(19) United States
(12) Patent Application Publication
(10) Pub. No.: US 2013/0312996 A1
(43) Pub. Date: Nov. 28, 2013

(54) PRESSURE BALANCED COILED TUBING CABLE AND CONNECTION

(71) Applicant: SCHLUMBERGER TECHNOLOGY CORPORATION, Sugar Land, TX (US)

(72) Inventor: Joseph Allan Nicholson, Broughton in Furness (GB)

(73) Assignee: SCHLUMBERGER TECHNOLOGY CORPORATION, Sugar Land, TX (US)

(21) Appl. No.: 13/892,272

(22) Filed: May 11, 2013

Related U.S. Application Data
(60) Provisional application No. 61/651,100, filed on May 24, 2012.

(51) Int. Cl. H02G 9/06; H02G 1/14

(52) U.S. Cl. CPC H02G 9/065; H02G 1/14
USPC 174/50.52; 174/68.3; 29/857

(57) ABSTRACT

An assembly can include at least three cables; a bedding spine to seat the at least three cables; and interlocking segments that lock the at least three cables to the bedding spine. Various other apparatuses, systems, methods, etc., are also disclosed.

### RELATED APPLICATIONS

This application claims the benefit of and priority to U.S. Provisional Application Ser. No. 61/651,100, filed 24 May 2012, which is incorporated by reference herein.

### BACKGROUND

Electrically or fluidly coupled downhole equipment rely on a cable or cables for delivery of electricity or fluid (e.g., hydraulic fluid), for example, to power the equipment, to control the equipment, to receive signals from the equipment, etc. Downhole environments may be harsh, for example, physically (e.g., consider temperature and pressure) and chemically (e.g., consider chemical corrosion). Some examples of downhole equipment include downhole heaters, downhole pumps and downhole gauges (e.g., sensors). As an example, a downhole heater may be installed at a bottom of a well to increase the temperature of fluid coming from the reservoir (e.g., to reduce fluid viscosity). As another example, a downhole heater may be installed as a heater treater, for example, to assist with elimination of paraffin deposits, hydrate plugs, etc. (e.g., optionally with delivery of a treatment fluid). As an example, a downhole pump may be an electric submersible pump (ESP) to achieve artificial lift of fluid. As an example, a downhole gauge (e.g., sensor) may be coupled to a fiber optic cable for transmission of information. As an example, a hydraulically coupled piece of equipment may respond to hydraulic pressure, flow, etc., optionally to change state (e.g., switching), to communication information (e.g., pulse telemetry), etc.

Various technologies, techniques, etc., described herein pertain to cables and coupling mechanisms, for example, for one or more pieces of equipment that may be positioned in a borehole, a well, or other environment.

### SUMMARY

An assembly can include at least three cables; a bedding spine to seat the at least three cables; and interlocking segments that lock the at least three cables to the bedding spine.

An assembly can include an end cap that includes a through bore for receipt of tubing, a tubing clamp and a connection mechanism; a seal compression housing that includes a proximal end, a distal end, a through bore for receipt of tubing, a proximal end connection mechanism and a distal end connection mechanism that couples to the connection mechanism of the end cap for alignment of the through bore of the end cap and the through bore of the seal compression housing; a seal component that includes an aperture for receipt of tubing; a housing that includes a proximal end, a distal end, an interior end surface located between the proximal end and the distal end, an extension that extends from the distal end that includes a seat that seats the seal component and a connection mechanism that couples to the connection mechanism of the seal compression housing, a housing through bore that extends from the seat of the extension to the interior end surface, where coupling of the connection mechanism of the extension and the connection mechanism of the seal compression housing aligns the housing through bore and through bore of the seal compression housing, a bellows cavity, a boot seal cavity; a bellows disposed in the bellows cavity of the housing where the bellows includes an inner space and at least one port to fluidly couple the inner space to an external environment; a boot seal component disposed in the boot cavity of the housing that includes an aperture for receipt of tubing; and a cable connector connected to the proximal end of the housing to connect cables carried by tubing that extends through the through bore of the end cap, the through bore of the seal compression housing, the aperture of the seal component and the aperture of the boot seal, the cables being pressure balanced with respect to an external environment via the bellows.

A method can include preparing cables carried by coiled tubing for connection to a connector of an end termination assembly; inserting the coiled tubing into the end termination assembly; connecting the cables to the connector; clamping the coiled tubing via a collect clamp of the end termination assembly; sealing the coiled tubing via a compression seal component of the end termination assembly; sealing the coiled tubing via a boot seal component of the end termination assembly; and introducing dielectric material into the end termination assembly. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates an example of an electric submersible pump (ESP) system that includes a variable speed drive (VSD);

FIG. 2 illustrates an example of coiled tubing;

FIG. 3 illustrates examples of coiled tubing;

FIG. 4 illustrates an example of an end termination assembly for coiled tubing;

FIG. 5 illustrates an example of a crown plug with a wet-mate connector for attachment to the end termination assembly of FIG. 4;

FIG. 6 illustrates an example of a housing that includes a bellows;

FIG. 7 illustrates an example of an end cap for a cable clamp (e.g., a coiled tubing clamp) and an example of a seal compression housing for a cable seal (e.g., a coiled tubing seal);

FIG. 8 illustrates an example of a boot seal for a cable (e.g., a coiled tubing);

FIG. 9 illustrates an example of an assembly;

FIG. 10 illustrates examples of assemblies;

FIG. 11 illustrates an example of a method and examples of components that can form a sub-assembly for coiled tubing; and

FIG. 12 illustrates an example of a method.

### DETAILED DESCRIPTION

The following description includes the best mode presently contemplated for practicing the described implementations. This description is not to be taken in a limiting sense, but rather is made merely for the purpose of describing the general principles of the implementations. The scope of the described implementations should be ascertained with reference to the issued claims.

In oil wells that are produced with the use of one or more electric submersible pumps (ESPs), coiled tubing is sometimes used in place of coupled tubing to deploy the ESP. As an example, the ESP power cable may be contained within the coiled tubing. Installation and retrieval of the coiled tubing and ESP may be accomplished by accessing an open end of the coiled tubing in order to connect or disconnect the power cable.

In subsea or land based coiled tubing systems, for example, where the coil tubing is deployed at great depths, the external pressure on the coil casing and end connection systems can be excessive and restrict the design of the coil to resist the collapse pressure. Also making coil tubing with a power cable inside it for several kilometers in length can pose challenges. Approaches that rely on cable injection to inject cable into coil tubing may be limited, for example, to continuous lengths of about 3 km.

For deepwater offshore installations it may be desirable to deploy a coiled tubing ESP cable system with minimal non-productive rig time (NPT). For example, consider using a coil and end connection system that can be quickly and reliably made up on the drill floor and which can be deployed subsea at great depth and which is also designed to resist the effects of high external pressure.

An ESP or other downhole equipment may include one or more electrically powered components. As an example, a motor may be driven via a 3-phase power supply and a power cable or cables that provide a 3-phase AC power signal. Voltage and current levels of a 3-phase AC power signal provided by a power supply to an ESP motor may be, for example, of the order of kilovolts and tens of amperes.

As an example, an ESP may include one or more sensors (e.g., gauges) that measure any of a variety of phenomena (e.g., temperature, pressure, vibration, etc.). A commercially available sensor is the Phoenix MultiSensor™ marketed by Schlumberger Limited (Houston, Tex.), which monitors intake and discharge pressures; intake, motor and discharge temperatures; and vibration and current-leakage. An ESP monitoring system may include a supervisory control and data acquisition system (SCADA). Commercially available surveillance systems include the espWatcher™ and the LiftWatcher™ surveillance systems marketed by Schlumberger Limited (Houston, Tex.), which provide for communication of data, for example, between a production team and well/field data equipment (e.g., with or without SCADA installations). Such a system may issue instructions to, for example, start, stop or control ESP speed via an ESP controller.

As to power to power a sensor (e.g., an active sensor), circuitry associated with a sensor (e.g., an active or a passive sensor), or a sensor and circuitry associated with a sensor, a DC power signal may be provided via an ESP cable and available at a wye point of an ESP motor, for example, powered by a 3-phase AC power signal. As an example, a sensor may be battery powered or powered via flow of fluid (e.g., via a generator). In various examples, a sensor may include a cable or line for purposes of transmission of information, power, etc.

As an example, a power cable may provide for delivery of power to an ESP, other downhole equipment or an ESP and other downhole equipment. Such a power cable may also provide for transmission of data to downhole equipment, from downhole equipment or to and from downhole equipment.

As to issues associated with ESP operations, a power supply may experience unbalanced phases, voltage spikes, presence of harmonics, lightning strikes, etc., which may, for example, increase temperature of an ESP motor, a power cable, etc.; a motor controller may experience issues when subjected to extreme conditions (e.g., high/low temperatures, high level of moisture, etc.); an ESP motor may experience a short circuit due to debris in its lubricating oil, water breakthrough to its lubricating oil, noise from a transformer which results in wear (e.g., insulation, etc.), which may lead to lubricating oil contamination; and a power cable may experience a issues (e.g. short circuit or other) due to electric discharge in insulation surrounding one or more conductors (e.g., more probable at higher voltages), poor manufacturing quality (e.g., of insulation, armor, etc.), water breakthrough, noise from a transformer, direct physical damage (e.g., crushing, cutting, etc.) during running or pulling operations), chemical damage (e.g., corrosion), deterioration due to high temperature, current above a design limit resulting in temperature increase, electrical stresses, etc.

Some of the foregoing examples of issues may be germane to operation of other types of downhole equipment. For example, cable related issues may apply to a downhole heater installation. In various examples, cables and coupling mechanisms, for example, to power one or more pieces of equipment that may be positioned in a borehole, a well, or other environment, are illustrated or described with respect to an ESP installation; noting that such cable and coupling mechanisms may be employed for other types of equipment.

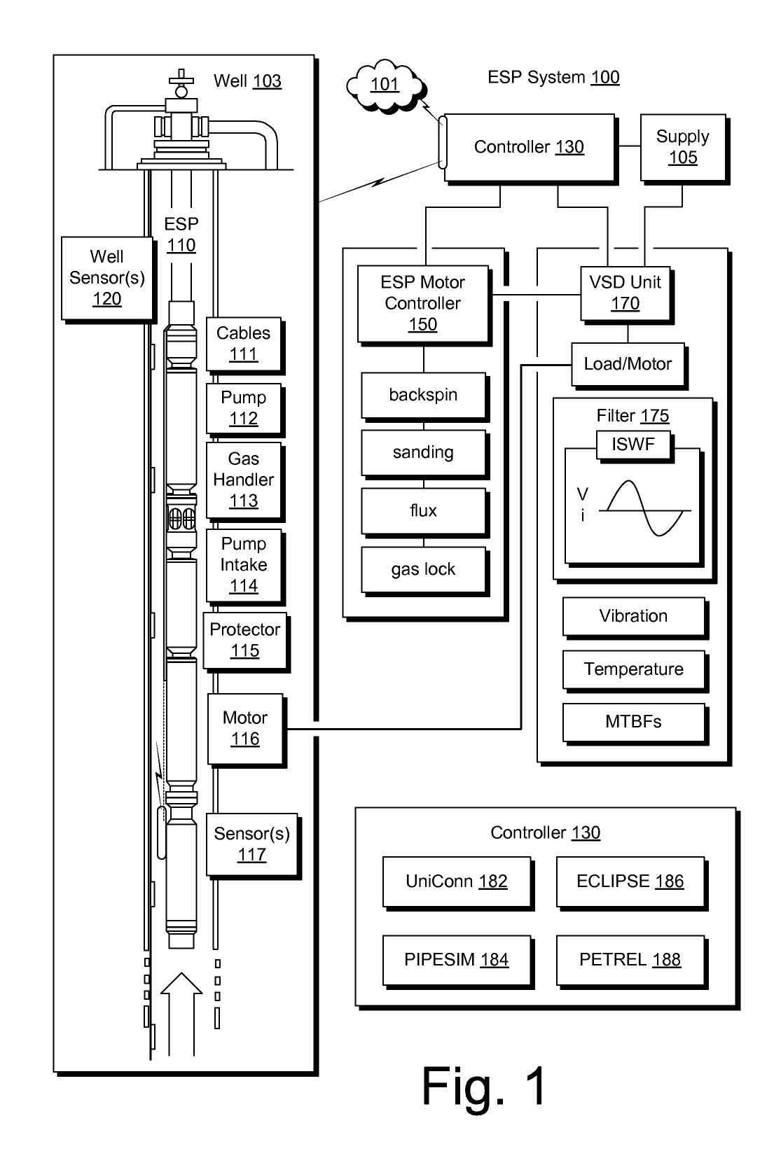

FIG. 1 shows an example of an ESP system 100 as including a network 101, a well 103 disposed in a geologic environment, a power supply 105, an ESP 110, a controller 130, a motor controller 150 and a VSD unit 170. The power supply 105 may receive power from a power grid, an onsite generator (e.g., natural gas driven turbine), or other source.

In the example of FIG. 1, the well 103 includes a wellhead that can include a choke (e.g., a choke valve). For example, the well 103 can include a choke valve to control various operations such as to reduce pressure of a fluid from high pressure in a closed wellbore to atmospheric pressure. Adjustable choke valves can include valves constructed to resist wear due to high-velocity, solids-laden fluid flowing by restricting or sealing elements. A wellhead may include one or more sensors such as a temperature sensor, a pressure sensor, a solids sensor, etc.

The ESP 110 includes cables 111, a pump 112, gas handling features 113, a pump intake 114, a protector 115, a motor 116, and one or more sensors 117 (e.g., temperature, pressure, current leakage, vibration, etc.). The well 103 may include one or more well sensors 120, for example, such as the commercially available OpticLine™ sensors or WellWatcher BriteBlue™ sensors marketed by Schlumberger Limited (Houston, Tex.). Such sensors may be fiber optic-based and provide for real time sensing of temperature, for example, in steam-assisted gravity drainage (SAGD) or other operations (e.g., enhanced oil recovery, etc.). With respect to SAGD, as an example, a well may include a relatively horizontal portion. Such a portion may collect heated heavy oil responsive to steam injection and an ESP may be positioned horizontally to enhance flow of the heavy oil.

In the example of FIG. 1, the controller 130 can include one or more interfaces, for example, for receipt, transmission or receipt and transmission of information with the motor controller 150, a VSD unit 170, the power supply 105 (e.g., a gas fueled turbine generator, a power company, etc.), the network 101, equipment in the well 103, equipment in another well, etc.

As shown in FIG. 1, the controller 130 can include or provide access to one or more modules or frameworks. Further, the controller 130 may include features of an ESP motor controller and optionally supplant the ESP motor controller 150. For example, the controller 130 may include the UniConn™ motor controller 182 marketed by Schlumberger Limited (Houston, Tex.). In the example of FIG. 1, the controller 130 may access one or more of the PIPESIM™ framework 184 marketed by Schlumberger Limited (Houston, Tex.), the ECLIPSE™ framework 186 marketed by Schlumberger Limited (Houston, Tex.) and the PETREL™ framework 188 marketed by Schlumberger Limited (Houston, Tex.).

In the example of FIG. 1, the motor controller 150 may be a commercially available motor controller such as the UniConn™ motor controller. The UniConn™ motor controller can connect to a SCADA system, the espWatcher™ surveillance system marketed by Schlumberger Limited (Houston, Tex.), etc. The UniConn™ motor controller can interface with fixed speed drive (FSD) controllers or a VSD unit, for example, such as the VSD unit 170.

For FSD controllers, the UniConn™ motor controller can monitor ESP system three-phase currents, three-phase surface voltage, supply voltage and frequency, ESP spinning frequency and leg ground, power factor and motor load.

For VSD units, the UniConn™ motor controller can monitor VSD output current, ESP running current, VSD output voltage, supply voltage, VSD input and VSD output power, VSD output frequency, drive loading, motor load, three-phase ESP running current, three-phase VSD input or output voltage, ESP spinning frequency, and leg-ground.

In the example of FIG. 1, the ESP motor controller 150 includes various modules to handle, for example, backspin of an ESP, sanding of an ESP, flux of an ESP and gas lock of an ESP. As mentioned, the motor controller 150 may include any of a variety of features, additionally, alternatively, etc.

In the example of FIG. 1, the VSD unit 170 may be a medium voltage drive (MVD) unit or a low voltage drive (LVD). For a MVD, a VSD unit can include an integrated transformer and control circuitry. As an example, the VSD unit 170 may receive power with a voltage of about 4.16 kV and control a motor as a load with a voltage from about 0 V to about 4.16 kV. As an example, a MVD VSD unit may operate using voltage levels up to about 6 kV. In contrast, a LVD may operate with three phase, multilevel PWM in a range from about 0 V to an input voltage level, which may be, for example, about 380 V or, for example, up to about 480 V. As an example, a range for a MVD may be from about 1 kV to about 6 kV.

The VSD unit 170 may include commercially available control circuitry such as the SpeedStar™ MVD control circuitry marketed by Schlumberger Limited (Houston, Tex.). The SpeedStar™ MVD control circuitry is suitable for indoor or outdoor use and may include a visible fused disconnect switch, precharge circuitry, and sine wave output filter 175 (e.g., integral sine wave filter, ISWF) tailored for control and protection of ESP circuitry (e.g., an ESP motor).

In the example of FIG. 1, the VSD unit 170 is shown along with a plot of a sine wave (e.g., achieved via the sine wave output filter 175) and modules that may provide for responsiveness to vibration, responsiveness to temperature and management to reduce mean time between failures (MTBFs). As an example, the VSD unit 170 may be rated with an ESP to provide for about 40,000 hours (5 years) of operation at a temperature of about 50 C with about a 100% load. The VSD unit 170 may include surge and lightening protection (e.g., one protection circuit per phase). As to leg-ground monitoring or water intrusion monitoring, such types of monitoring can indicate whether corrosion is or has occurred. Further monitoring of power quality from a supply, to a motor, at a motor, may occur by one or more circuits or features of a controller.

While the example of FIG. 1 shows an ESP with centrifugal pump stages, another type of ESP may be controlled. For example, an ESP may include a hydraulic diaphragm electric submersible pump (HDESP), which is a positive-displacement, double-acting diaphragm pump with a downhole motor. HDESPs find use in low-liquid-rate coalbed methane and other oil and gas shallow wells that may implement artificial lift to remove water from the wellbore. A HDESP can be set above or below the perforations and run in wells that are, for example, less than about 2,500 ft deep and that produce less than about 200 barrels per day. HDESPs may handle a wide variety of fluids and, for example, up to about 2% sand, coal, fines and H₂S/CO₂. As to materials of construction, materials such as, for example, those used in commercially available REDA™ or other submersible pumps for use in the oil and gas industry may be used.

In various examples, techniques and technologies for cables and cable coupling assemblies may help to eliminate failure points, reduce on-site human errors, speed-up field installation, speed-up field retrieval, etc. As an example, “cable” may refer to coiled tubing or, for example, an individual cable carried by coiled tubing. As an example, a cable coupling assembly may provide for coupling coiled tubing and coupling one or more cables carried by the coiled tubing. For example, one end of an assembly may receive coiled tubing and another end of the assembly may provide for coupling to one or more cables carried by the coiled tubing. Such an assembly may be an end termination assembly (e.g., for coiled tubing).

As an example, a pressure balanced coiled tubing and connection assembly may include steel coil construction that supports power cables and optionally other cable or line-based services (e.g., hydraulic, electrical lines, fiber optics, etc.). In such an example, the coiled tubing may be formed as a substantially solid, supported tubing system. As an example, as to connections, an end termination may provide pressure compensation to coiled tubing.

As an example, coiled tubing may provide a fully supported tubing construction using a solid cable structure making the coil relatively impervious to external pressure. As an example, coiled tubing may include extruded filler sections with interlocking features to encapsulate and support power and interspersed service cables within a steel jacket of the coiled tubing.

As an example, a steel jacket may be formed by rolling or bending around interior components (e.g., cable, filler sections, etc.) and, for example, it may then be seam welded. As an example, a steel jacket of coiled tubing may be cold drawn (e.g., or cold rolled) down on diameter to positively grip the cable. As an example, a steel jacket may be vented to allow fluids to enter coiled tubing and thereby balance pressure therein, if desired.

As an example, a method of manufacture for coiled tubing may allow for production of continuous lengths of coil tubing. For example, where coil tubing weight and size may be minimized, for example, to allow for lighter service vessels to be deployed (e.g., for subsea installations, etc.).

As an example, cable end termination connections (e.g., for ESP or other equipment) may provide a way to gas test at the end termination seal integrity thereby providing a quality check on the seal system.

As an example, an end termination system may provide for pressure compensation, for example, optionally without hydraulic access to coil tubing from a subsea or land based tree system. Such an example may help to reduce cost for a subsea system, for example, alleviating hydraulic valve access at the tree or through a surface umbilical. Such a reduction in complexity may help to improve overall system reliability.

As an example, a coiled tubing and connection assembly may include end terminations that are both compact and relatively simple to make up on a rig floor. As an example, where cables are encapsulated within extrusions, separation of the extrusions from the cables may be simplified as to performing tasks for making end terminations (e.g., rather than trying to cut the cables out of any extruded jacket material).

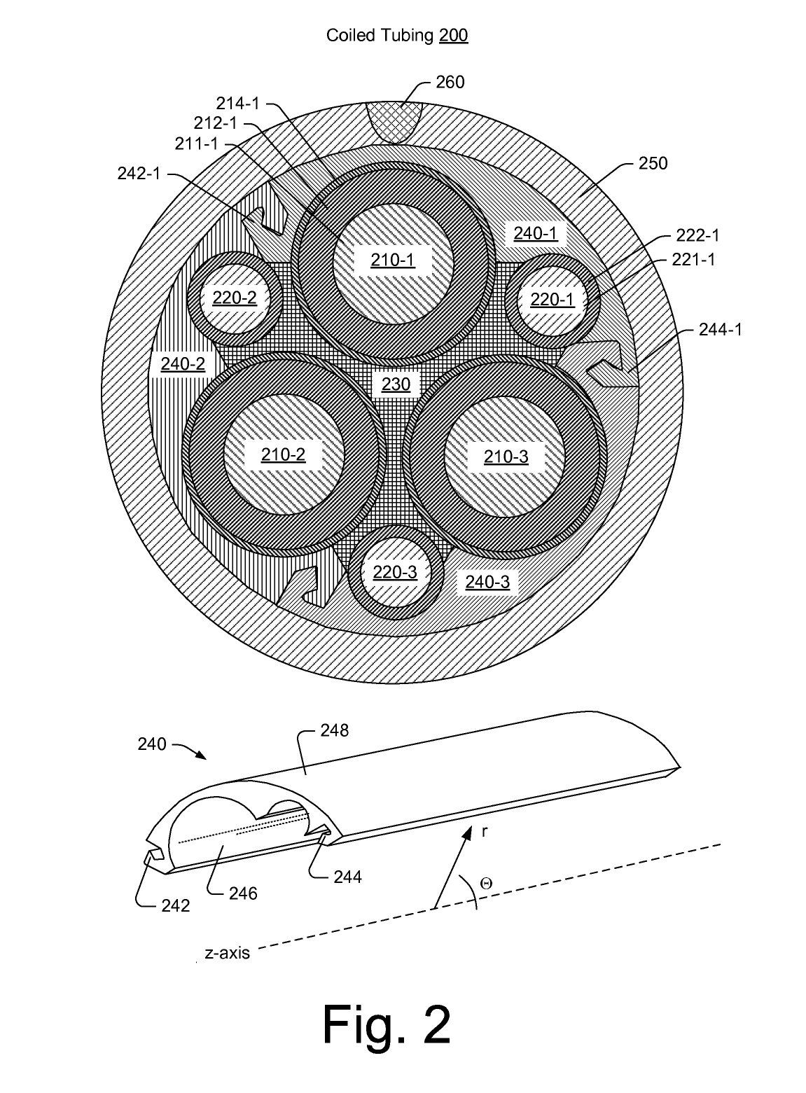

FIG. 2 shows a cross-sectional view of an example of coiled tubing 200 and a perspective view of an interlocking segment 240, three of which are disposed and interlocked in the coiled tubing 200. A cylindrical coordinate system is shown as having a z-axis as well as radial and azimuthal dimensions r and Θ, respectively. As may be appreciated, any feature of the coiled tubing 200 may be defined, described, etc., with respect to the cylindrical coordinate system. For example, the interlocking segment 240 may be defined with respect to z, r and Θ coordinates. Further, spatial relationships may be specified using z, r and Θ.

In the example of FIG. 2, the coiled tubing 200 includes three main cables 210-1, 210-2 and 210-3 and three secondary cables 220-1, 220-2 and 220-3. As shown, the main cables 210 and the secondary cables 220 are supported by a bedding section 230 (e.g., a bedding spine) about which the interlocking segments 240-1, 240-2 and 240-3 are peripherally disposed (e.g., in a tessellated manner). An outer casing 250, which may include a weld joint 260, encases the main cables 210-1, 210-2 and 210-3, the secondary cables 220-1, 220-2 and 220-3, the bedding section 230 and the interlocking segments 240-1, 240-2 and 240-3.

As shown in the example of FIG. 2, the main cables 210-1, 210-2 and 210-3 may include respective layers. For example, referring to the cable 210-1 may include a conductor 211-1, surrounded by an insulation layer 212-1 surrounded by a protection layer 214-1 (e.g., a cable jacket shield layer). As an example, a cable may include screened cable construction for additional assurance at higher voltages. For example, a cable may include one or more semi-conductor screens (consider, e.g., an inner semi-conductor screen disposed about a conductor and/or an outer semi-conductor screen over insulation). As an example, the secondary cables 220, with reference to the cable 220-1, may include a core 221-1 surrounded by another layer 222-1 (e.g., an insulator, a protector or shield, etc.).

As shown in the example of FIG. 2, the interlocking segments 240-1, 240-2 and 240-3, with reference to the perspective view of the interlocking segment 240, may include a groove side 242 and a rib side 244 where the groove side 242 may interlock with a rib side of another one of the interlocking segments 240 and where the rib side 244 may interlock with a groove side of another one of the interlocking segments 240. The interlocking segment 240 may include a substantially curved outer surface 248, which may be compressed within a bore formed by the outer casing 250 (e.g., as the outer casing 250 is formed about the interlocking segments 240-1, 240-2 and 240-3 and components supported thereby). In the example of FIG. 2, each of the interlocking segments 240-1, 240-2 and 240-3 is configured to seat one of the main cables 210-1, 210-2 and 210-3 and one of the secondary cables 220-1, 220-2 and 220-3 (e.g., in conjunction with the bedding section 230).

In the example of FIG. 2, the bedding section 230 has a triangular shape that provides for locating the main cables 210-1, 210-2 and 210-3 along legs and locating the secondary cables 220-1, 220-2 and 220-3 at vertexes. As an example, the main cables 210-1, 210-2 and 210-3 may be positioned along a first diameter and the secondary cables 220-1, 220-2 and 220-3 may be positioned along a second diameter, for example, slightly larger than the first diameter. The overall arrangement of the centers of the main cables 210-1, 210-2 and 210-3 and the secondary cables 220-1, 220-2 and 220-3 approximates points of a hexagram (e.g., optionally with two different sized triangles).

As an example, the bedding section 230 may be an extruded spine bedding section and, for example, made of a material such as FEP, ETFE, or another high performance thermoplastic material. As an example, the main cables 210-1, 210-2 and 210-3 may be provided for carrying 3-phase power signals to a motor. For example, the conductor 211-1 of the main cable 210-1 may be made of copper, the insulation layer 212-1 may be made of EPDM, EPR, PEEK or XLPE insulation material and the protection layer 214-1 may be made of a fluoropolymer (e.g., FEP, ETFE or XLPE or similar for added mechanical/chemical protection).

As an example, with reference to the secondary cable 220-1, where it is configured as a hydraulic line with a lumen for transmission of hydraulic fluid, hydraulic fluid pressure, etc., the protection layer 212-1 may be made of steel tube conduit (e.g., consider INCONEL® alloy or 316L stainless steel; (e.g., INCONEL® alloy as marketed by Specialty Materials Corporation, New Hartford, N.Y.)).

As an example, with reference to the secondary cable 220-1, where it is configured as an electrical line, the protection layer 212-1 may be made of steel (e.g., consider INCONEL® alloy or stainless steel) that surrounds a mono-conductor, twisted pair, etc.

As an example, the interlocking segment 240 may be made via extrusion and, for example, of a material such as FEP, ETFE, XLPE, etc.

As an example, the outer casing 250 may be made of steel (e.g., consider INCONEL® 625 alloy, INCONEL® 825 alloy, a super duplex (e.g., duplex stainless steel), 316L stainless steel or similar corrosion resistant material (e.g., optionally selected depending on subsea or other environmental conditions).

As an example, coil tubing may be constructed using two extrusion profiles. For example, consider the bedding section 230 serving as a spine section configured to space apart power and instrumentation lines preventing chafing and, for example, reducing electrical stress concentrations between each of phase in a multi-phase system as well as the steel jacketed cables themselves. Further, as an example, consider the interlocking segments 240-1, 240-2 and 240-3 as forming an outer protection jacket made up of several extrusions (e.g., three or more akin to the interlocking segment 240) that interlock as they are compressed together, which may act to protect and position inner cables via the interlocking process.

As an example, during manufacture of coiled tubing, a spine section may be passed through a series of dies or rollers, for example, where each of the service and power cables could be directed into the spine section to form a tight bundle. As this is carried out, the cables could be twisted in a helical manner, for example, to achieve approximately one revolution about each 1 meter to about each 2 meters. In such a manner, the cables encased in the coiled tubing are not put in any substantial tension or compression when the coiled tubing is later coiled on a drum (e.g., a spool).

As an example, as coiled tubing manufacture proceeds along a cable lay-up process, the interlocking segments 240-1, 240-2 and 240-3 may be added to secure a cable structure (e.g., cables 210-1, 210-2, 210-3, 220-1, 220-2 and 220-3 and bedding section 230). As an example, a sub-assembly including the interlocking segments 240-1, 240-2 and 240-3 may be passed through a set of dies or rollers to compress the interlocking segments 240-1, 240-2 and 240-3 into position. In such an example, interlocking ribs and grooves of the interlocking segments 240-1, 240-2 and 240-3, rather like a zipper, may be forced together in a gradual process around the cables 210-1, 210-2, 210-3, 220-1, 220-2 and 220-3, following a natural helical form with the cables 210-1, 210-2, 210-3, 220-1, 220-2 and 220-3 supported inside.

With the interlocking jacket formed by the interlocking segments 240-1, 240-2 and 240-3 about the cables 210-1, 210-2, 210-3, 220-1, 220-2 and 220-3 and the bedding section 230, a sub-assembly of the coiled tubing may be coiled onto a drum ready for transportation to a coiled tubing manufacturer's facility (e.g., for forming the outer casing 250).

As an example, the outer casing 250 may be produced in much the same way as coil tubing is made, for example, using strip sheet material and passing the strip sheet material through a series of rollers to form a tube shape. As an example, when the strip is formed to a cup or “C” shape, a sub-assembly may be laid into the tube, which may be closed by further rolling and forming. After a seam formed by the processed strip sheet material has been closed, the resulting coil tubing may be welded (see, e.g., the weld 260 for the outer casing 250); for example, by using a laser, T.I.G (tungsten inert gas) to form a low heat generating fusion weld. A welding operation may be controlled to avoid damaging one or more of the interlocking segments 240-1, 240-2 and 240-3, the bedding section 230 and the cables 210-1, 210-2, 210-3, 220-1, 220-2 and 220-3. As an example, a process for smaller instrumentation cables may be adapted and scaled for larger diameter coiled tubing.

As an example, after sealing an outer casing (e.g., along a seam or seams), the resulting coiled tubing may be cold drawn or cold rolled to reduce its diameter and create a tight fit onto components therein (e.g., to help prevent movement and slippage).

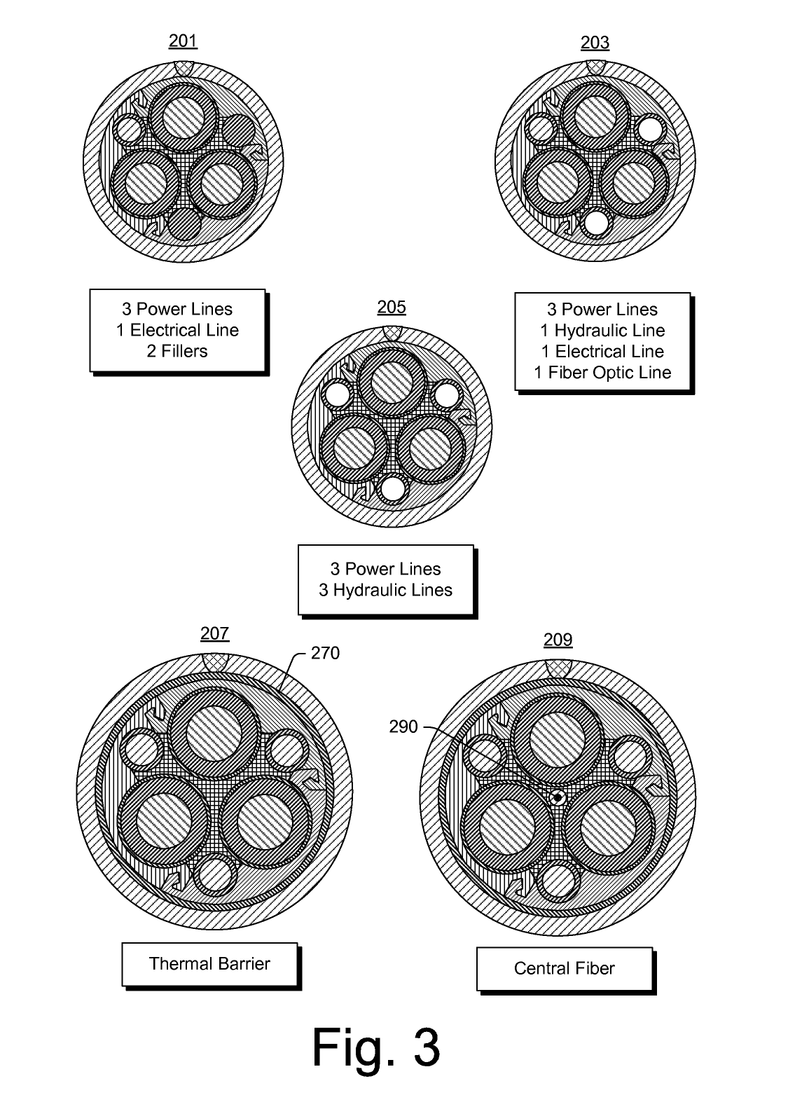

FIG. 3 shows example configurations as coiled tubing 201, 203 and 205, which may optionally use the same type of modular extrusions (e.g., bedding section 230 and three of the interlocking segments 240). As shown, the coiled tubing 201 includes three power lines as main cables, one electrical line as a secondary cable and two fillers to fill spaces for two other secondary cables. As shown, the coiled tubing 203 includes three power lines as main cables and a hydraulic line, an electrical line and a fiber optic line as secondary cables. As shown, the coiled tubing 205 includes three power lines as main cables and three hydraulic lines as secondary cables.

FIG. 3 also shows an example configuration of coiled tubing 207 that includes a thermal barrier layer 270 disposed between a layer formed by three of the interlocking segments 240 and the outer casing 250. Such an example may provide for thicker walled construction to withstand heavier loading. As shown, where a heavier walled section is desired, the thermal barrier layer 270 may be formed using tape, which may be added, for example, to protect an umbilical cable from weld heat energy. As an example, a barrier tape may be made of or include a refractory material such as a ceramic impregnated glass cloth or similar material, or aluminum/titanium foil or similar material to dissipate heat.

FIG. 3 further shows an example configuration of coiled tubing 209 that includes a central fiber 290. In such an example, the spine 230 may include a bore for the fiber 290, which may be configured to provide information about the coiled tubing 209. For example, the fiber 290 may be configured to provide information as to temperature, stress, etc., which may be used to assess integrity, performance, etc. of the coiled tubing 209.

As an example, the fiber 290 may be part of a system such as a fiber-optic distributed temperature sensing (DTS) system that can provide temperature measurements over a length of the fiber. Such a system may provide sensitive and accurate measurements that may identify one or more sources of change in a well (e.g., optionally in real time).

As an example, the fiber 290 may be used for communication, optionally in addition to sensing. For example, a fiber may be used for sensing and/or for communication between a downhole sensor and a surface unit. As an example, a fiber may be composed of multiple fibers, for example, to lower loss rates, prolong system life and enhancing spatial resolution. As an example, multiple fibers may capture more backscatter light when compared to a single fiber, thereby shortening time to reach a particular temperature resolution.

As an example, a fiber may be configured for acquisition of distributed temperature data, pressure data, electrical data, and/or one or more other types of data associated with phenomena that may be experienced by a cable, whether during manufacture, during deployment or during use in a downhole environment. For example, during construction, the fiber 290 may be used for monitoring coiling, temperature, stress, etc. In such an example, acquired data may be used for quality control and/or feedback control of a construction process. With respect to deployment of coiled tubing that includes the fiber 290, acquired data may provide for monitoring of quality in conjunction with one or more deployment parameters (e.g., speed of deployment, etc.).

As an example, coiled tubing may include a centrally disposed fiber optic cable that provides for one or more of monitoring stress and/or strain, for distributed temperature measurement, etc. when the coiled tubing is being manufactured, deployed, in-service, retrieved, etc. As an example, an end termination assembly can include a coupling mechanism to couple to such a fiber optic cable for purposes of monitoring (e.g., via a downhole unit, a surface unit, etc.).

As an example, the coiled tubing 200 may be compact and incompressible to support cables, effectively transferring external pressure to the inside cable and supporting filler extrusions (e.g., the bedding section 230 and the three interlocking segments 240). As an example, the coiled tubing 200 may be fitted to an end termination assembly, for example, to form a system that can operate effectively at high external pressures. In such an example, the end termination assembly may include features to achieve pressure balance with respect to an external environment.

As an example, an assembly can include at least three cables; a bedding spine to seat the at least three cables; and interlocking segments that lock the at least three cables to the bedding spine. In such an example, the bedding spine may be an extruded bedding spine and/or each of the interlocking segments may be an extruded interlocking segment.

As an example, an interlocking segment may include a rib and a groove. As an example, an assembly may include three interlocking segments. As an example, an assembly may include an outer casing disposed about interlocking segments. As an example, such an assembly may be coiled tubing. As an example, an outer casing of an assembly may be seam welded and cold drawn.

As an example, an assembly may include three power cables and at least another cable such as one or more electrical, hydraulic and/or optical cables. As an example, an assembly may include three power cables for a 3-phase motor of an electric submersible pump.

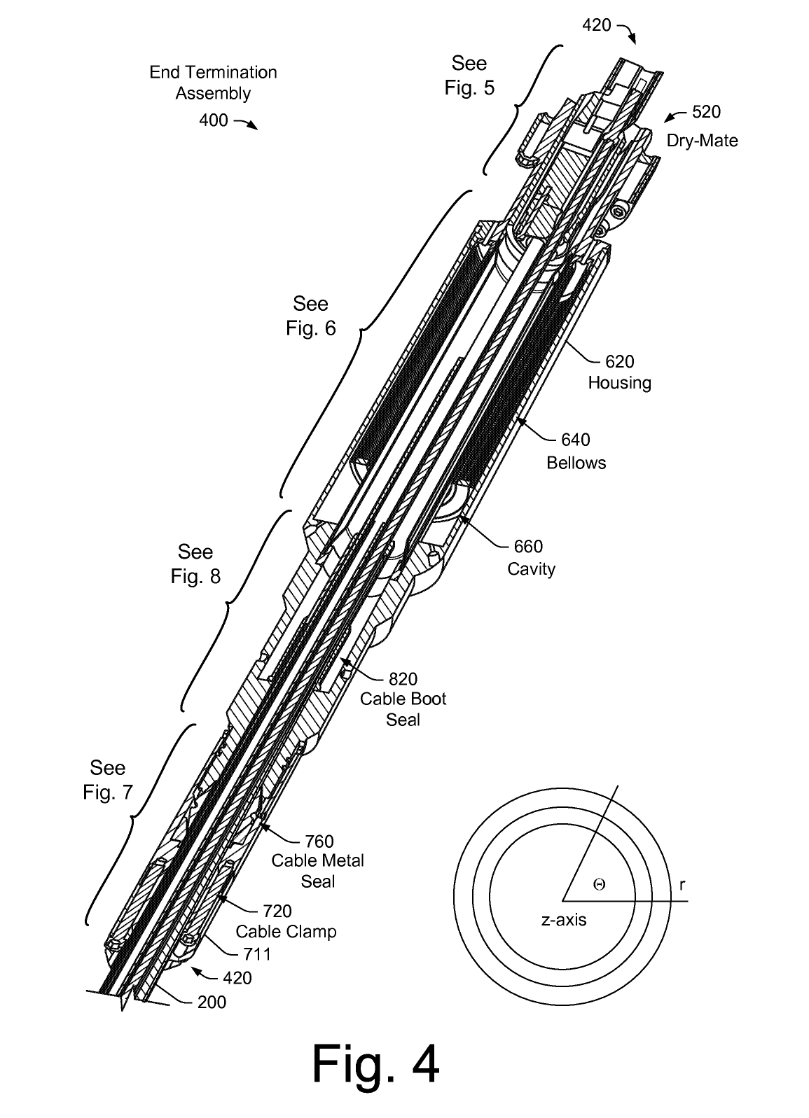

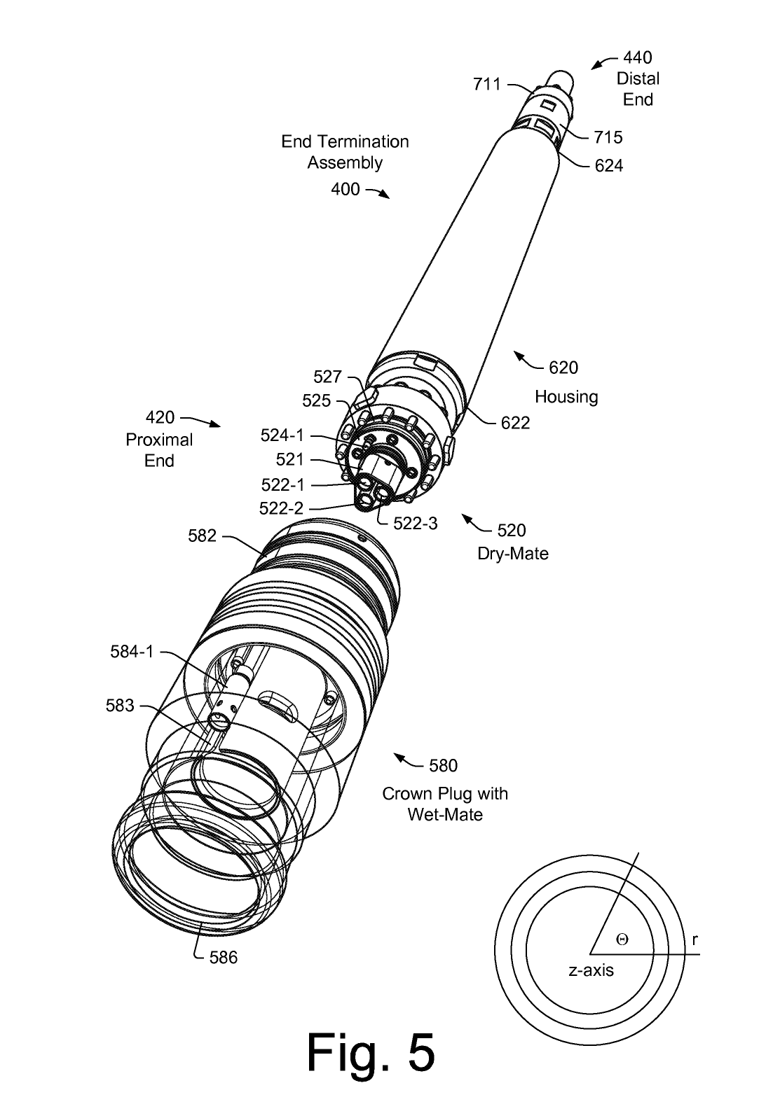

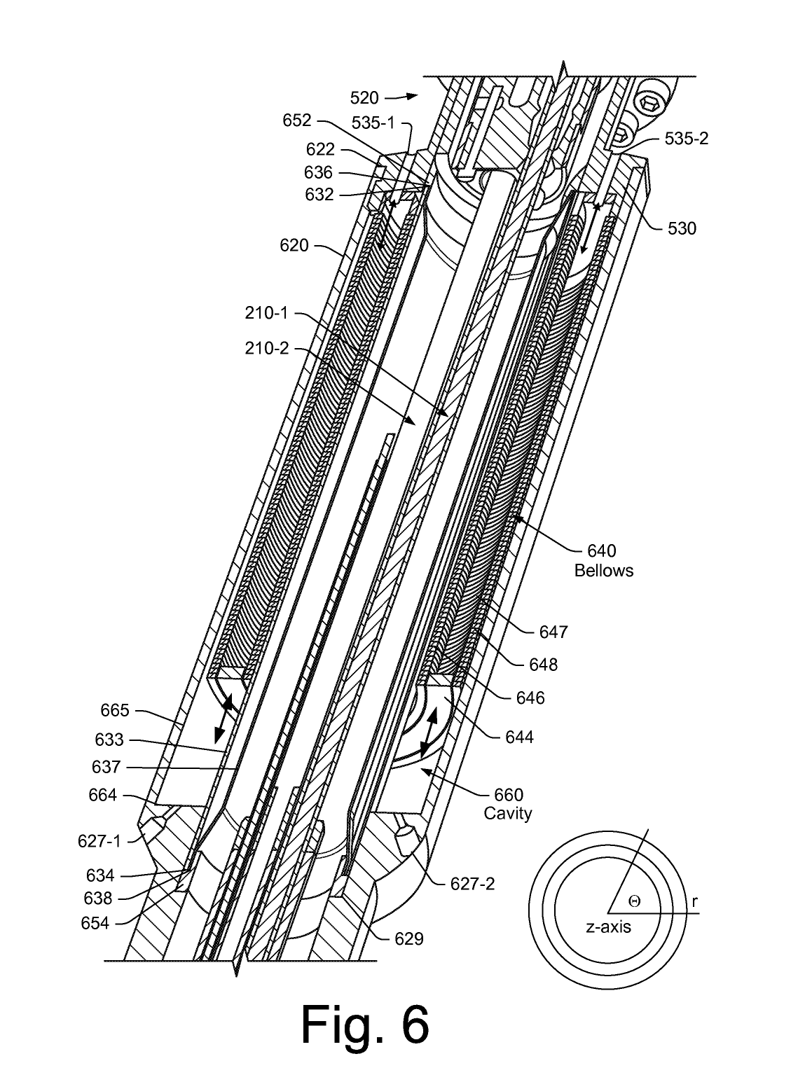

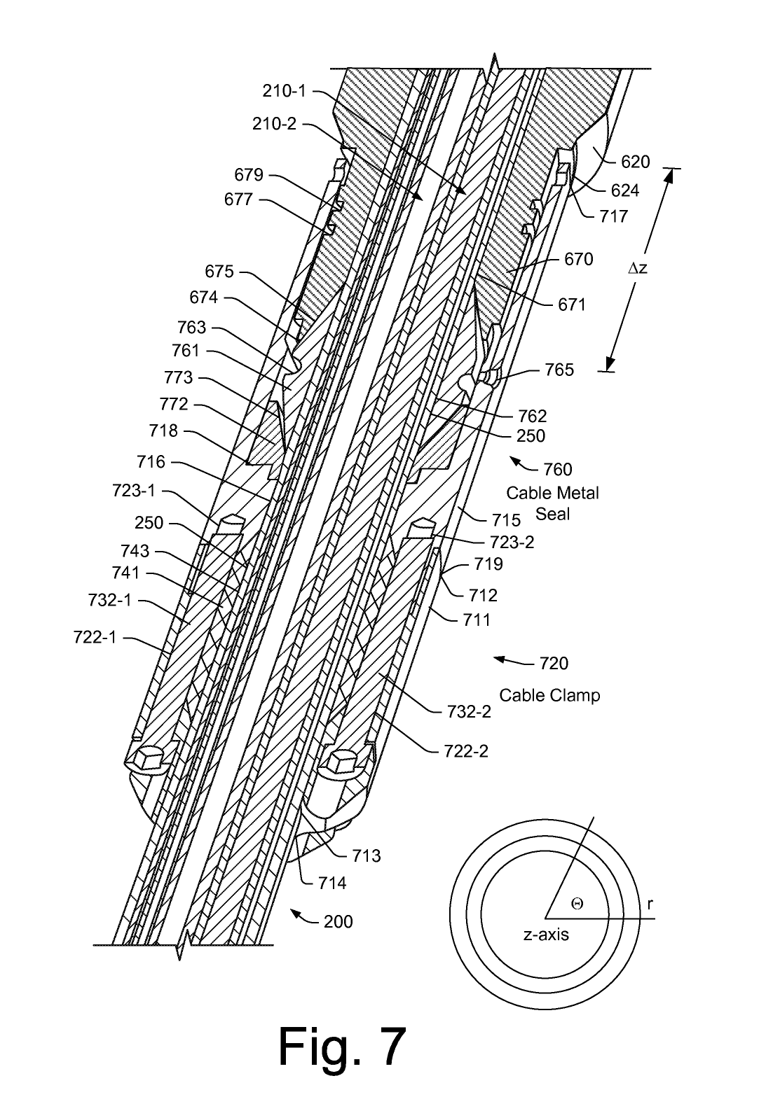

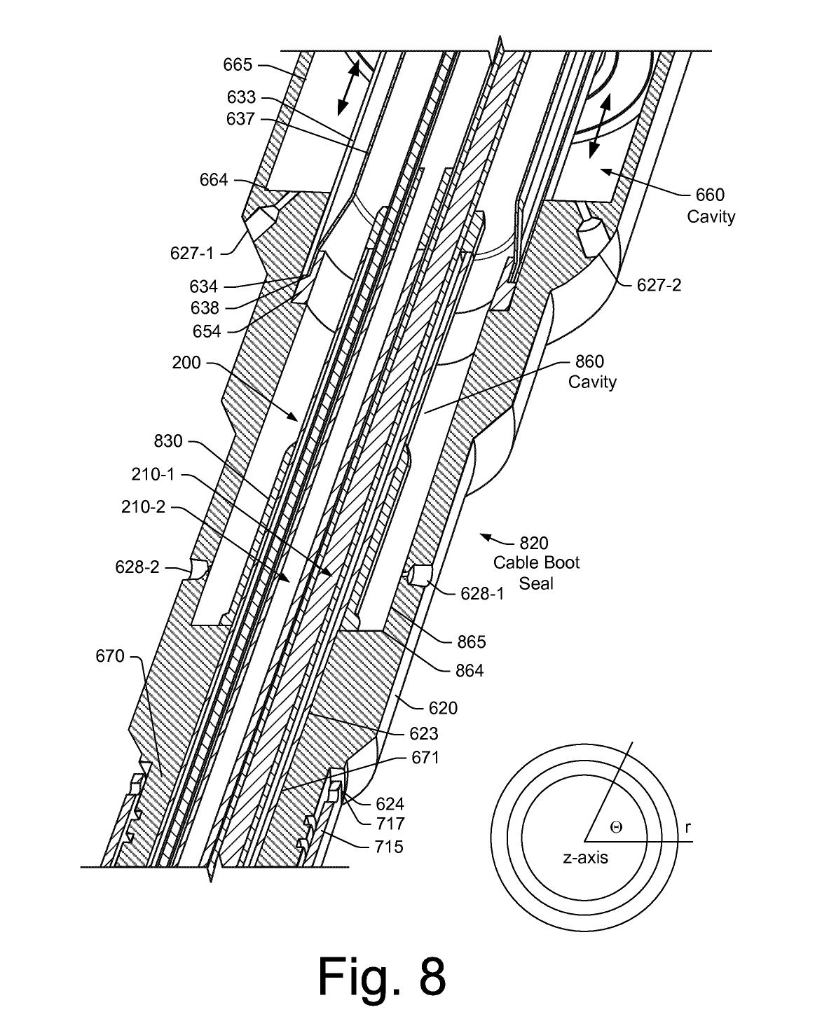

FIG. 4 shows a cut-away view of an end termination assembly 400 as including a dry-mate connector 520 at a proximal end 420 (see, e.g., FIG. 5) and a cable clamp 720 in an end cap 711 at a distal end 440 (see, e.g., FIG. 7), which receives coiled tubing 200. The assembly 400 includes, disposed axially between the proximal end 420 and the distal end 440, a housing 620 with bellows 640 disposed in a proximal cavity 660 of the housing 620 (see, e.g., FIG. 6), a cable boot seal 820 (see, e.g., FIG. 8), a cable metal seal 760 and the cable clamp 720 (see, e.g., FIG. 7).

A cylindrical coordinate system is shown as having a z-axis as well as radial and azimuthal dimensions r and Θ, respectively. As may be appreciated, any feature of the assembly 400 may be defined, described, etc., with respect to the cylindrical coordinate system. Further, spatial relationships may be specified using z, r and Θ.

FIG. 5 shows a perspective view of the end termination assembly 400 along with a crown plug with a wet-mate connector 580. As indicated, the crown plug with the wet-mate connector may connect to the dry-mate connector 520 of the assembly 400 at the proximal end 420 of the assembly 400. In the example of FIG. 5, the housing 620 of the assembly 400 is shown as including a proximal end 622 and a distal end 624. The distal end 624 of the housing 620 includes an extension that is received via a seal compression housing 715 to which the end cap 711 may be fit and tightened (e.g., to energize a compression seal within the seal compression housing 715). As an example, a cable termination assembly may include a crown plug, for example, integrally formed as a wet-mate connection system.

In the example of FIG. 5, the housing 620 receives at its proximal end 420 the dry-mate connector 520, which includes dry-mate features such as a mating surface 527, an axial face 525, a plug 521 extending from the axial face 525 where the plug 521 provides termination points for cables disposed within the housing 620. For example, the plug 521 may include three termination points 522-1, 522-2 and 522-3 for three power cables as carried in coiled tubing (see, e.g., the coiled tubing 200 of FIG. 2, the various coiled tubings of FIG. 3, etc.).

In the example of FIG. 5, the crown plug with the wet-mate connector 580 includes a coupling member 582 to couple to the dry-mate connector 520 and internal features such as a wet mateable receptacle connector (see, e.g., U.S. Pat. No. 7,112,080, which is incorporated by reference herein) 584-1 for a secondary cable (see, e.g., the cables 220-1, 220-2 and 220-3), a three phase power wet-mate receptacle connector (see, e.g., U.S. Pat. No. 7,731,515, which is incorporated by reference herein) 583 for one or more main cables (see, e.g., the cables 210-1, 210-2 and 210-3) and an end 586 with an opening to receive one or more cables (e.g., individually, in tubing, etc.). The crown plug with the wet-mate connector 580 may be configured to couple to a tree such as, for example, a tree for subsea operations. As an example, the assembly 400, via the crown plug with the wet-mate connector 580, may couple a power source to coiled tubing for a motor such as, for example, a motor of an ESP. As an example, a wet-mate crown plug may include one or more wet-mate hydraulic and/or fiber optic couplers, for example, as well as one or more power and/or instrumentation devices.

FIG. 6 shows a cut-away view of a portion of the housing 620 of the assembly 400 with the dry-mate connector 520 connected via a flange 530 to the proximal end 624 of the housing 620. As shown, the housing 620 includes a bore wall 665 and an end wall 664 that form the proximal cavity 660. The bellows 640 have an annular, cylindrical form with an inner space 647 that may receive fluid via one or more fluid ports 535-1 and 535-2 disposed in the flange 530 of the dry-mate connector 520. For example, the fluid ports 535-1 and 535-2 (e.g., which may optionally be fitted with filters to stop blockage via particle accumulation, etc.) may allow external fluid (e.g., in a completion) to enter the inner space 647 of the bellows 640 such that the bellows expands axially in the cavity 660. As to the inner space 647 of the bellows 640, it may be defined by a distal end wall 644 that caps an axially expandable cylindrical inner wall 646 and an axially expandable cylindrical outer wall 648, which form the bellows 640.

As shown, the housing 620 may include one or more fluid ports 627-1 and 627-2 to the proximal cavity 660, for example, with openings at the end wall 662 of the housing 620. Fluid may be introduced into the cavity 660, for example, to provide for pressure balancing with respect to fluid in the inner space 647 of the bellows 640. As an example, each of the ports 627-1 and 627-2 may then be sealed, for example, with a pressure tight screw, an NPT plug, a welded plug, etc.

In the example of FIG. 6, disposed interiorly to the bellows 640 are a vented cylindrical wall 633 and a diaphragm wall 637, positioned radially interiorly to the vented cylindrical wall 633. As an example, the vented cylindrical wall 633 may act as a surrounding support sleeve for the diaphragm wall 637, where the vented cylindrical wall 633 may be constructed from metal and where the diaphragm wall 637 may be constructed from an elastomeric material. As shown, a proximal end 632 of the vented cylindrical wall 633 and a proximal end 636 of the diaphragm wall 637 are received in a fitting 652 at or near the proximal end 622 of the housing 620 while a distal end 634 of the vented cylindrical wall 633 and a distal end 638 of the diaphragm wall 637 are received in a fitting 654 set in a shoulder 629 of the housing 620. In such an example, the fitting 654 may seal the distal ends 634 and 638 of the walls 633 and 637 with respect to the housing 620.

FIG. 7 shows a cut-away view of a portion of the assembly 400 that includes the cable clamp 720 and the cable metal seal 760 (see, e.g., FIG. 4). As shown in FIG. 7, at the distal end 624 of the housing 620, a proximal end 717 of the seal compression housing 715 is fit over an extension 670 of the housing 620, for example, via a bayonet, threads, or other mechanism. In such an example, the seal compression housing 715 may be tightened onto the housing 620 to compress a seal component 761. One or more annular grooves 677 and 679 may provide for locating one or more seal elements, for example, to form one or more seals between the seal compression housing 715 and the housing 620.

As to the seal component 761, as an example, it may be a ferrule with an inner surface 762 that defines an aperture for receiving and interfacing with an outer surface of the outer casing 250 of the coiled tubing 200. As an example, the seal compression housing 715 may include a distal bore neck 716 and a shoulder 718, located proximally with respect to the distal bore neck 716. The shoulder 718 may seat a compression fitting component 772 that includes a conical surface 773 for forming a distal compression interface with the seal component 761. As to a proximal compression interface, the extension 670 of the housing 620 may include a conical surface 675 that extends proximally from a distal end 674 of the extension 670 of the housing 620. In such an example, as the seal compression housing 715 is torqued onto the housing 620, a compressive force is applied to the compression fitting component 772, which transmits force to the seal component 761, which transmits force to the extension 670 of the housing 620. In such a manner, where coiled tubing 200 runs through the aperture of the seal component 761, various seal interfaces are formed. Where the seal component 761 is made of metal and the outer casing 250 of the coiled tubing 200 is made of metal, a metal-to-metal seal interface is formed. Further, where the compression fitting component 772 is made of metal, another metal-to-metal seal interface is formed. Yet further, where the extension 670 of the housing 620 is made of metal (e.g., optionally integral to the housing 620, which may be made of metal), yet another metal-to-metal seal interface is formed.

In the example of FIG. 7, the seal component 761 may include an annular groove 763 to seat a seal component. As an example, the seal compression housing 715 may include a sealable port 765, which may receive fluid to pressure test one or more seal interfaces.

As to the cable clamp 720, the end cap 711 includes a distal end 714 and a proximal end 712 where the distal end 714 includes an opening to receive the coiled tubing 200 in a through bore 713 as well as openings for connection mechanism bores 722-1 and 722-2 to receive bolts 732-1 and 732-2 (e.g., or studs, nuts and studs, etc.). As an example, the bores 722-1 and 722-2 may align with bores 723-1 and 723-2 in the seal compression housing 715 (e.g., as part of a connection mechanism to couple the end cap 711 and the seal compression housing 715).

Within the end cap 711, a collet 741 is positioned that includes an inner surface 743, for example, that can include integrally machined teeth or serrations so as to bite into the outer casing 250 and thereby grip the coiled tubing 200. As shown, the inner surface 743 forms an aperture for receipt of the coiled tubing 200. As an example, the collet 741 may be formed as a collar that can be positioned around the coiled tubing and to exert a clamping force on the coiled tubing when the bolts 732-1 and 732-2 are torqued (e.g., tightened). As an example, studs and nuts may be provided for applying force to the collet 741.

As an example, noting that the view of FIG. 7 is a cut-away view, the number of tightening mechanisms (e.g., bolts, studs, etc.) may be greater than two (e.g., consider three, four or more). Where the coiled tubing 200 connects to a piece of equipment, it may support that equipment as well as the weight of the length of coiled tubing that extends to the piece of equipment (e.g., one or more ESPs and/or other equipment). In such an example, the cable clamp 720 of the assembly 400 may be formed with sufficient integrity to support that weight (e.g., and force of normal movements). Accordingly, the tightening mechanisms of the end cap 711 perform two functions, to secure the end cap 711 to the seal compression housing 715 and hence the housing 620 of the assembly 400 and to secure the coiled tubing 200 (e.g., or other tubing) to the assembly 400.

In the example of FIG. 7, the coiled tubing 200 is shown as passing through the end cap 711 where it is clamped by the collet 741, passing through the bore neck 716 of the seal compression housing 715 (e.g., as a through bore of the seal compression housing 715) where it is then sealed by the seal component 761 and then passing through a bore 671 of the extension 670 of the housing 620. As shown, the extension 670 may have an axial length Δz between its distal end 674 and the distal end 624 of the housing 620, which may be sufficient for a coupling mechanism (e.g., bayonet, threads, etc.) and for seating the seal component 761 and one or more related components (e.g., the compression fitting component 772).

FIG. 8 shows a cut-away view of the cable boot seal 820 of the assembly 400 (see, e.g., FIG. 4. As shown, the housing 620 includes a distal cavity 860 defined by a wall 865 and an axial end surface 864. As shown the coiled tubing 200 extends from the bore 671 of the extension 670 of the housing 620 (e.g., and an adjoining bore 623 of the housing 620) and into the distal cavity 860 where it is received by a boot seal component 830. The boot seal component 830 may be secured to the coiled tubing 200 by stretch fitting and then by applying a radial compression force by means of a garter spring, plastic ring, clip, etc., in a manner that applies force to the axial end surface 864.

In the example of FIG. 8, the housing 620 includes one or more sealable ports 628-1 and 628-2 that are in fluid communication with the distal cavity 860. Such ports may be used to pressure test one or more seals (e.g., seal interfaces) associated with the proximal cavity 860 as well as one or more seals (e.g., seal interfaces) associated with the walls 633 and 637 and one or more seals (e.g., seal interfaces) associated with the dry-mate connector 520 (see, e.g., FIGS. 4, 5 and 6). In the example of FIG. 8, the ports 628-1 and/or 628-2 may be used to fill the cavity 860 with a dielectric gel, for example, that acts as a pressure transmitting medium via the diaphragm wall 637. In such an example, use of gel rather than oil may help prevent loss of fluid, for example, which may flow via cable interstices (e.g., if the cable boot seal 830 were to be compromised). Use of gel may also help prevent migration of water (e.g., if a seal or seals were to be compromised). As an example, a gel may have a higher viscosity than oil, which may make migration of the gel more difficult when compared to oil).

As an example, the bellows 640 may be made of metal (e.g., a metallic bellows with the internal and external convoluted sections 646 and 648 forming a cylinder inside the tubular housing 620). As an example, the bellows may be arranged so as to compensate both for internal expansion of dielectric oil, gel, etc. and for compressibility of materials inside coiled tubing. As mentioned, ports 535-1 and 535-2 (optionally with additional ports) are in fluid communication with the inner space 647 of the bellows 640 as well as, for example, an external environment to provide communication with external pressure. As mentioned, interior to the bellows 640 is a diaphragm wall 637, sealed at its ends and optionally supported by a support vented wall 633 where at least the diaphragm wall 637 acts to seal the internal bore of the housing 620.

A sealed bellows cavity created by the internal diaphragm wall 637 allows the cavity 660 to be filled with a compensation medium which may be insulation oil such as a dielectric oil (e.g., or gel), silicone, or mineral oil or similar material. As an example, such a filling process may be carried out in a factory saving, for example, to save time on a rig floor.

As to the cable boot seal 820, it may be used to form a sealed cap over tubing (e.g., coiled tubing). As an example, the boot seal component 830 may be a cap that forms a seal, for example, such that when the assembly 400 provides for termination of the tubing, features can allow for a gas seal test (e.g., via nitrogen, air or helium) to be performed thereby ensuring that various seals are functioning correctly, for example, before filling one or more spaces (e.g., the cavity 860, the cavity 660, etc.) with dielectric gel, dielectric oil, etc.

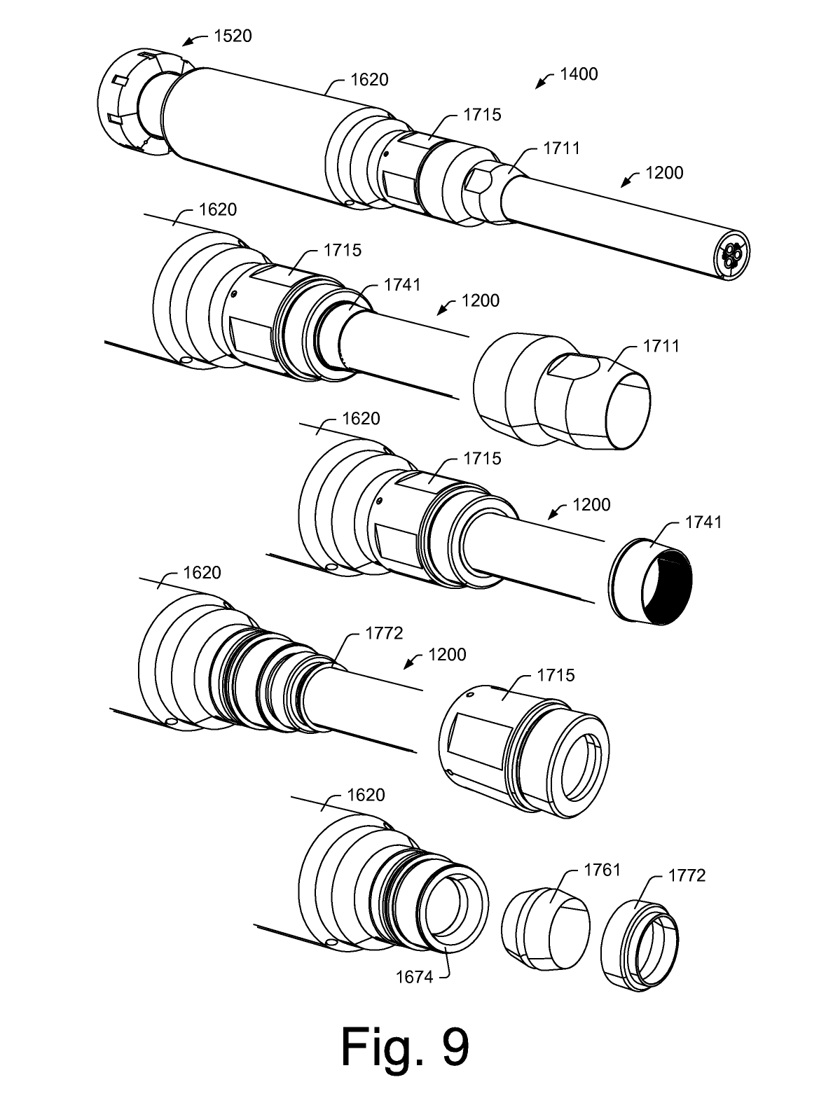

FIG. 9 shows a series of perspective views of an example of an end termination assembly 1400 that may terminate a coiled tubing 1200. As shown in the example of FIG. 9, the assembly 1400 includes a cable connector 1520, a housing 1620, a compression housing 1715 and an end cap 1711 where removal of the end cap 1711 reveals a collet 1741, where removal of the collet 1741 reveals a seating surface for seating the collet 1741 (e.g., against the compression housing 1715 and/or a seal component) and where removal of the compression housing 1715 reveals a compression fitting component 1772. In a lowermost perspective view of FIG. 9, the housing 1620 is shown with respect to a ferrule 1761 and the compression fitting component 1772 without the coiled tubing 1200. In such an example, the ferrule 1761 may be compressed between the housing 1620 and the compression fitting component 1772, for example, by tightening the compression housing 1715 onto the housing 1620 (e.g., via threads, bayonet, etc.). In FIG. 9, the end cap 1711 may include, for example, threads that engage other threads (e.g., or bayonet, or other mechanism) to tighten the end cap 1711 and apply force to the collet 1741, for example, to thereby cause the collet 1741 to grasp and secure coiled tubing (e.g., the coiled tubing 1200).

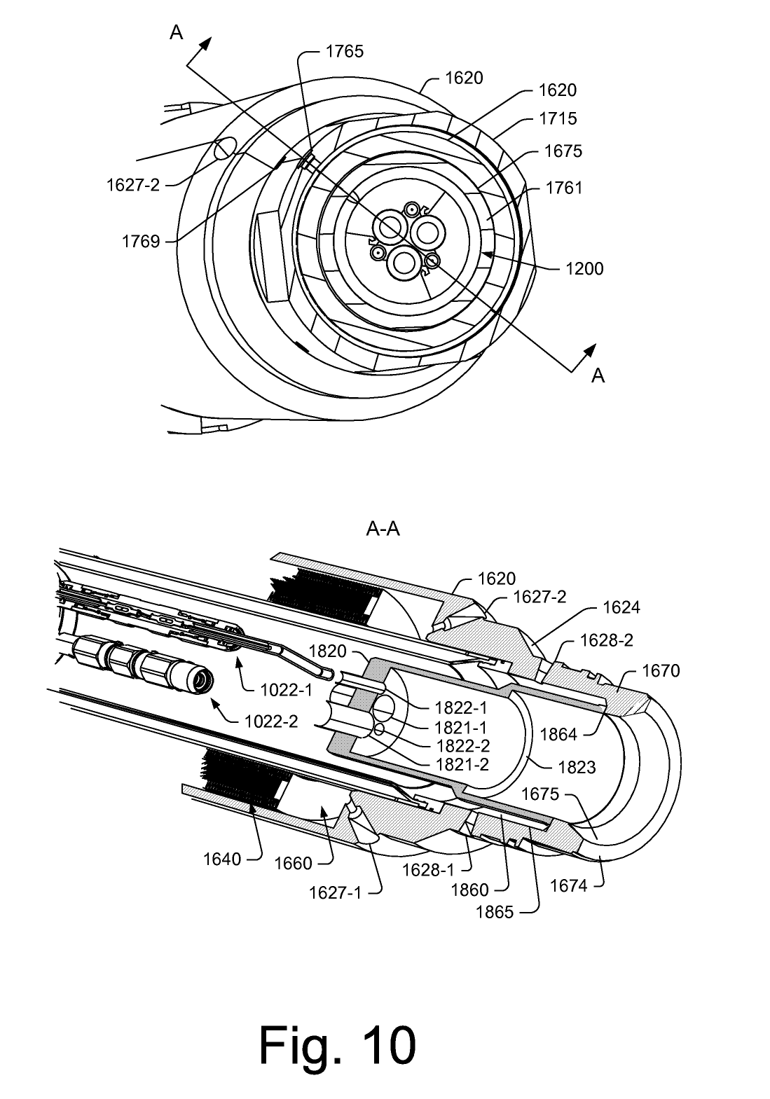

FIG. 10 shows two cross-sectional views through the assembly 1400 of FIG. 9. The upper cross-sectional view reveals various inner components of the coiled tubing 1200 as well as the ferrule 1761, a tapered surface 1675 of the housing 1620 and the compression fitting 1715, which includes a port 1765, for example, for testing seal interfaces therein. Also shown in the upper cross-sectional view of FIG. 10 is another port 1769 of the compression fitting 1715, which may be in fluid communication with or otherwise provide access to the port 1682-1, the port 1682-2, etc. of the housing 1620.

In the lower cross-sectional view of FIG. 10, the assembly 1400 is shown as including a bellows 1640, a cavity 1660, a cavity 1860 and ports 1627-1, 1627-2, 1628-1 and 1628-2. As shown, a boot seal 1820 is disposed in the cavity 1860, which is defined in part by a wall 1865 of the housing 1620. The boot seal 1820 is seated against an end wall 1864 of the housing 1620 that extends radially outwardly from a bore that includes the tapered surface 1675, which seats the ferrule 1761. For example, an extension 1670 extends from an end 1624 of the housing 1620 where the tapered surface 1675 extends to an end 1674 of the extension 1670. In the example of FIG. 10, the boot seal 1820 includes various openings 1821-1, 1821-2, 1822-1 and 1822-2 to receive cables or fibers of the coiled tubing 1200 (e.g., main cables or secondary cables). Various coupling mechanisms 1022-1 and 1022-2 are also shown, for example, to couple to secondary cables that pass through respective openings 1822-1 and 1822-2 of the boot seal 1820. The boot seal 1820 also includes an annular shoulder 1823, which may, for example, seat an end of an outer case of the coiled tubing 1200 (e.g., as the coiled tubing 1200 is received via an aperture at one end of the boot cable 1820 and where cables therein pass through respective their openings at another end of the boot cable 1820). In such a manner, the boot seal 1820 “steps-down” with respect to the coiled tubing 1200 to seal individual cables carried therein as they proceed axially to respective termination points (e.g., via couplers, coupling mechanisms, etc.).

As an example, an assembly can include an end cap that includes a through bore for receipt of tubing, a tubing clamp and a connection mechanism; a seal compression housing that includes a proximal end, a distal end, a through bore for receipt of tubing, a proximal end connection mechanism and a distal end connection mechanism that couples to the connection mechanism of the end cap for alignment of the through bore of the end cap and the through bore of the seal compression housing; a seal component that includes an aperture for receipt of tubing; a housing that includes a proximal end, a distal end, an interior end surface located between the proximal end and the distal end, an extension that extends from the distal end that includes a seat that seats the seal component and a connection mechanism that couples to the connection mechanism of the seal compression housing, a housing through bore that extends from the seat of the extension to the interior end surface, where coupling of the connection mechanism of the extension and the connection mechanism of the seal compression housing aligns the housing through bore and through bore of the seal compression housing, a bellows cavity, a boot seal cavity; a bellows disposed in the bellows cavity of the housing where the bellows includes an inner space and at least one port to fluidly couple the inner space to an external environment; a boot seal component disposed in the boot cavity of the housing that includes an aperture for receipt of tubing; and a cable connector connected to the proximal end of the housing to connect cables carried by tubing that extends through the through bore of the end cap, the through bore of the seal compression housing, the aperture of the seal component and the aperture of the boot seal, the cables being pressure balanced with respect to an external environment via the bellows.

As an example, an assembly can include a housing with at least one sealable port for introducing a dielectric material into a bellows cavity and/or at least one sealable port for introducing a dielectric material into a boot seal cavity. As an example, a cable connector can include a flange that includes at least one port for external fluid communication with at least one of the at least one port of the bellows. As an example, a seal compression housing can include at least one sealable port for pressure testing seal interfaces associated with the seal component.

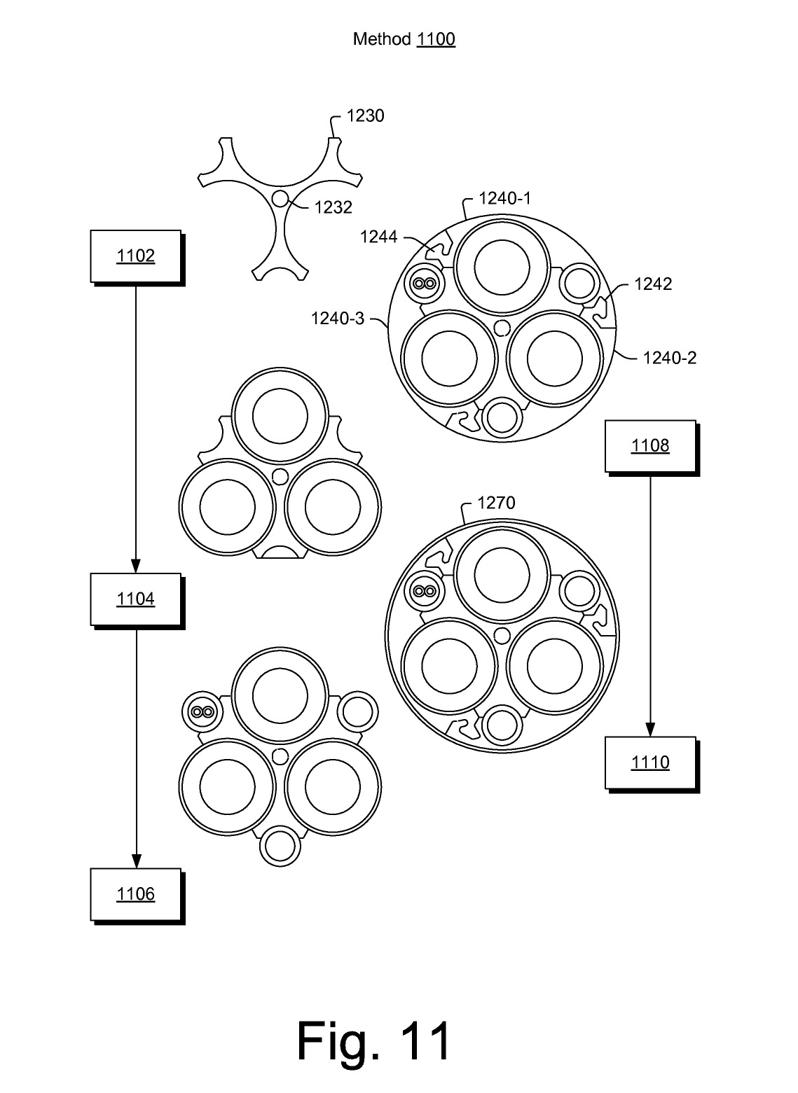

FIG. 11 shows an example of a method 1100 for constructing various components of coiled tubing. In FIG. 11, the method 1100 is shown in conjunction with examples of components of coiled tubing. For example, a bedding section 1230 (e.g., a bedding spine) is shown as including a bore 1232 for receipt of a cable, a fiber, etc.; a series of interlocking segments 1240-1, 1240-2 and 1240-3 are shown, for example, where each includes a groove side 1242 and a rib side 1244; and a thermal barrier layer 1270, for example, which may be encased by an outer casing.

In the example of FIG. 11, the method 1100 includes providing a fiber optic in a bedding section per block 1102, assembling main cables onto the bedding section 1104, assembling secondary cables onto the bedding section per block 1106, assembling a jacket of interlocking segments over the main cables and the secondary cables as assembled to the bedding section per block 1108 and wrapping the jacket with a thermal barrier material per block 1110. The method 1100 may further include encasing the thermal barrier material with a metal casing for forming coiled tubing.

As an example, the bedding section may be made of FEP. As an example, the main cables may be power cables (e.g., consider sizing of about #1/0 AWG). As an example, the secondary cables may include steel encapsulated twisted pair electrical cable (e.g., consider sizing of about #20 AWG) and/or may include hydraulic tubing (e.g., a hydraulic cable). As an example, the jacket made of interlocking segments may be made of FEP. As an example, the thermal barrier material forming a thermal barrier layer may be made of glass cloth with ceramic filler. As an example, an outer casing may be made of INCONEL® 625 alloy (e.g., having a wall thickness of about 0.16 inch and forming an outer diameter of about 1.750 inch).

As an example, a power cable may include a copper core, insulation (e.g., EPDM) and a fluoropolymer outer jacket layer (e.g., FEP). As an example, a secondary cable may include tin or silver coated cores with insulation (e.g., ETFE or FEP) and be encapsulated in an alloy (e.g., INCONEL® 625 or 826 alloy).

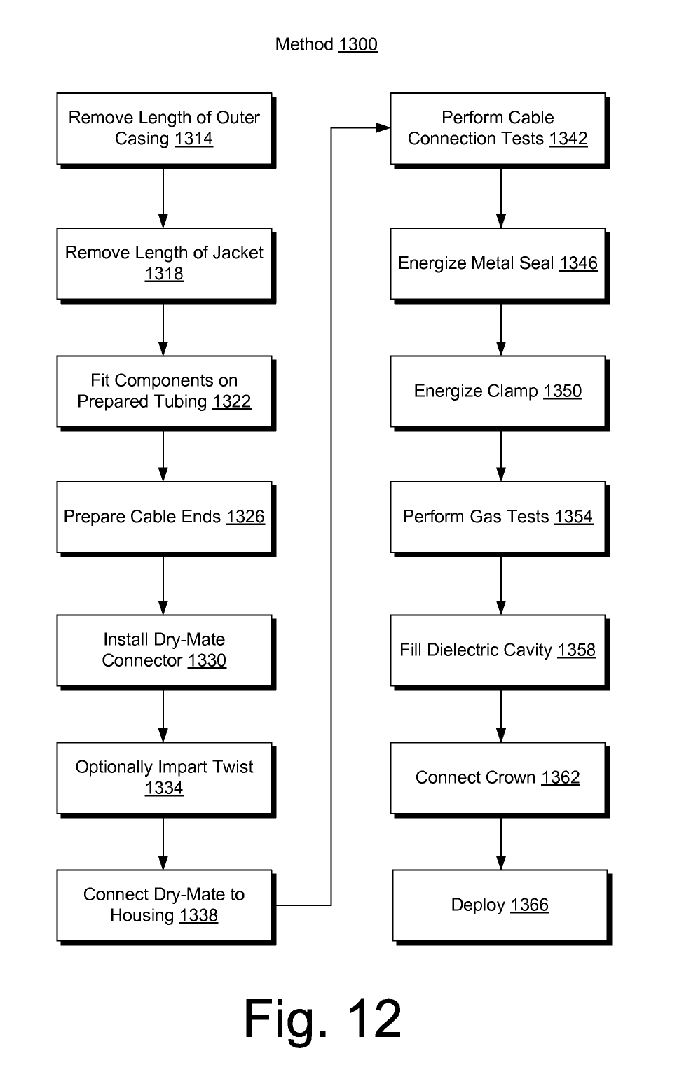

FIG. 12 shows a block diagram of an example of a method 1300 that can include a removal block 1314 for removing a length of outer casing from tubing (e.g., outer casing 250 of the tubing 200, 201, 203, 205, 207, etc.), a removal block 1318 for removing a length of a jacket (e.g., multiple interlocking segments 240 of the tubing 200, 201, 203, 205, 207, etc.), a fit block 1322 for fitting end termination components on the prepared tubing (e.g., with the aforementioned lengths removed), a preparation block 1326 for preparing ends of cables carried by the tubing, an installation block 1330 for installing a dry-mate connector to the cable ends, an optional twist block 1334 for imparting twist to the cables (e.g., or tubing), a connection block 1338 for connecting the dry-mate connector to a housing of an end termination assembly, a performance block 1342 for performing one or more cable connection tests (e.g., electrical, communication, etc.), an energize block 1346 for energizing a metal seal (see, e.g., the metal seal 760 of FIG. 7, the ferrule 1761 of FIG. 9), an energize block 1250 for energizing a clamp (see, e.g., the clamp 720 of FIG. 7, the collet 1741 of FIG. 9), a performance block 1354 for performing one or more gas seal tests, a fill block 1358 for filling one or more cavities with dielectric material, a connection block 1362 for connecting a crown connector, and a deployment block 1366 for deploying the tubing as attached to the assembled end termination assembly and, for example, as connected to a tree or other structure via the connected crown connector.

As an example, a method may include one or more of the follow actions: an outer metallic casing of coiled tubing is removed to a desired length revealing cables inside; a cable jacket is cut back to a desired length; cable clamping parts and an outer housing are slid down the tubing allowing a cable boot to be fitted and correctly seated; cable ends are prepared and crimp contacts fitted; a dry mate connector is installed onto the cables and optionally one or more other electrical services (e.g., instrumentation connections, etc. may be spliced to the appropriate tubing cores); one or more cables may be twisted to impart some extra cable length in the termination assembly; the housing is slid forward and dry mate connector engaged into the housing, for example, using a flange and retaining screws; electrical checks are made; a cable metal seal is energized by screwing up a seal compression housing to the main housing; a tubing clamping collet is energized using the compression bolts which are torque set; electrical tests and gas seal tests are performed; and a cavity or cavities are filled with dielectric gel or oil and port screws fitted. As an example, an assembled end termination assembly (e.g., the assembly 400, the assembly 1400) may be connected to a crown plug wet connector assembly (see, e.g., the connector 580) and deployed into a well (e.g., after final checks, etc.).

As an example, a method can include preparing cables carried by coiled tubing for connection to a connector of an end termination assembly; inserting the coiled tubing into the end termination assembly; connecting the cables to the connector; clamping the coiled tubing via a collect clamp of the end termination assembly; sealing the coiled tubing via a compression seal component of the end termination assembly; sealing the coiled tubing via a boot seal component of the end termination assembly; and introducing dielectric material into the end termination assembly. In such an example, the method may include installing the coiled tubing and the end termination assembly in a well.

As an example, a method may include pressure balancing coiled tubing in an end termination assembly by flowing well fluid into a bellows of the end termination assembly.

As an example, a method may include coupling a connector of an end termination assembly to a crown plug and, for example, coupling the crown plug to a subsea tree (e.g., for purposes of powering equipment such as, for example, an ESP).

### CONCLUSION

Although only a few examples have been described in detail above, those skilled in the art will readily appreciate that many modifications are possible in the examples. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. §112, paragraph 6 for any limitations of any of the claims herein, except for those in which the claim expressly uses the words “means for” together with an associated function.

What is claimed is:

1. An assembly comprising:
at least three cables;
a bedding spine to seat the at least three cables; and
interlocking segments that lock the at least three cables to the bedding spine.

2. The assembly of claim 1 wherein the bedding spine comprises an extruded bedding spine and wherein each of the interlocking segments comprises an extruded interlocking segment.

3. The assembly of claim 1 wherein each of the interlocking segments comprises a rib and a groove.

4. The assembly of claim 1 wherein the bedding spine comprises a central bore to seat an optical cable.

5. The assembly of claim 1 further comprising an outer casing disposed about the interlocking segments.

6. The assembly of claim 5 comprising coiled tubing.

7. The assembly of claim 1 comprising three power cables and at least another cable selected from a group consisting of electrical, hydraulic and optical cables.

8. The assembly of claim 5 wherein the outer casing comprises a seam welded and cold drawn outer casing.

9. The assembly of claim 1 comprising three power cables for a 3-phase motor of an electric submersible pump.

10. An assembly comprising:
an end cap that comprises a through bore for receipt of tubing, a tubing clamp and a connection mechanism;
a seal compression housing that comprises a proximal end, a distal end, a through bore for receipt of tubing, a proximal end connection mechanism and a distal end connection mechanism that couples to the connection mechanism of the end cap for alignment of the through bore of the end cap and the through bore of the seal compression housing;
a seal component that comprises an aperture for receipt of tubing;
a housing that comprises
a proximal end,
a distal end,
an interior end surface located between the proximal end and the distal end,
an extension that extends from the distal end that comprises a seat that seats the seal component and a connection mechanism that couples to the connection mechanism of the seal compression housing,
a housing through bore that extends from the seat of the extension to the interior end surface, wherein coupling of the connection mechanism of the extension and the connection mechanism of the seal compression housing aligns the housing through bore and through bore of the seal compression housing,
a bellows cavity, and
a boot seal cavity;
a bellows disposed in the bellows cavity of the housing wherein the bellows comprises an inner space and at least one port to fluidly couple the inner space to an external environment;
a boot seal component disposed in the boot cavity of the housing that comprises an aperture for receipt of tubing; and
a cable connector connected to the proximal end of the housing to connect cables carried by tubing that extend through the through bore of the end cap, the through bore of the seal compression housing, the aperture of the seal component and the aperture of the boot seal, the cables being pressure balanced with respect to an external environment via the bellows.

11. The assembly of claim 10 wherein the seal component comprises a ferrule.

12. The assembly of claim 10 wherein the housing comprises at least one sealable port for introducing a dielectric material into the bellows cavity.

13. The assembly of claim 10 wherein the housing comprises at least one sealable port for introducing a dielectric material into the boot seal cavity.

14. The assembly of claim 10 wherein the cable connector comprises a flange that comprises at least one port for external fluid communication with at least one of the at least one port of the bellows.

15. The assembly of claim 10 wherein the seal compression housing comprises at least one sealable port for pressure testing seal interfaces associated with the seal component.

16. A method comprising:
preparing cables carried by coiled tubing for connection to a connector of an end termination assembly;
inserting the coiled tubing into the end termination assembly;
connecting the cables to the connector;
clamping the coiled tubing via a collect clamp of the end termination assembly;
sealing the coiled tubing via a compression seal component of the end termination assembly;
sealing the coiled tubing via a boot seal component of the end termination assembly; and
introducing dielectric material into the end termination assembly.

17. The method of claim 16 comprising installing the coiled tubing and the end termination assembly in a well.

18. The method of claim 17 comprising pressure balancing the coiled tubing in the end termination assembly by flowing well fluid into a bellows of the end termination assembly.

19. The method of claim 16 comprising coupling the connector to a crown plug and coupling the crown plug to a subsea tree.

20. The method of claim 16 comprising monitoring strain of the coiled tubing via a fiber optic cable carried by the coiled tubing.
